(19) United States
(12) Patent Application Publication
(10) Pub. No.: US 2009/0196261 A1
(43) Pub. Date: Aug. 6, 2009

(54) RESOURCE ALLOCATION FOR ENHANCED UPLINK USING A SHARED CONTROL CHANNEL

(75) Inventors: Sharad Deepak Sambhwani, San Diego, CA (US); Wei Zeng, San Diego, CA (US)

Correspondence Address: QUALCOMM INCORPORATED, 5775 MOREHOUSE DR., SAN DIEGO, CA, 92121, US

(73) Assignee: QUALCOMM, Incorporated, San Diego, CA (US)

(21) Appl. No.: 12/345,246

(22) Filed: Dec. 29, 2008

Related U.S. Application Data
(60) Provisional application No. 61/019,194, filed on Jan. 4, 2008.
(60) Provisional application No. 61/020,031, filed on Jan. 9, 2008.

(51) Int. Cl. H04B 7/216

(52) U.S. Cl. 370/335

(57) ABSTRACT

Techniques for supporting operation with enhanced uplink are described. A user equipment (UE) may select a signature from a set of signatures available for random access for enhanced uplink, generate an access preamble based on the selected signature, and send the access preamble for random access while operating in an inactive state. The UE may receive allocated resources (e.g., for an E-DCH) for the UE from a shared control channel (e.g., an HS-SCCH). In one design, the UE may determine a pre-assigned UE identity (ID) associated with the selected signature, de-mask received symbols for the shared control channel based on the pre-assigned UE ID, decode the demasked symbols to obtain a codeword, and determine the allocated resources based on the codeword. The UE may send data to a Node B using the allocated resources while remaining in the inactive state.

### I. Claim of Priority under 35 U.S.C. §119

The present application for patent claims priority to Provisional U.S. Application Ser. No. 61/019,194, filed Jan. 4, 2008, and Provisional U.S. Application Ser. No. 61/020,031, filed Jan. 9, 2008, both entitled “E-DCH RESOURCE ALLOCATION SCHEME IN CELL_FACH,” assigned to the assignee hereof, and expressly incorporated herein by reference.

### BACKGROUND

I. Field

The present disclosure relates generally to communication, and more specifically to techniques for allocating resources in a wireless communication system.

II. Background

Wireless communication systems are widely deployed to provide various communication services such as voice, video, packet data, messaging, broadcast, etc. These systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of Node Bs that can support communication for a number of user equipments (UEs). A UE may communicate with a Node B via the downlink and uplink. The downlink (or forward link) refers to the communication link from the Node B to the UE, and the uplink (or reverse link) refers to the communication link from the UE to the Node B.

A UE may be intermittently active and may operate in (i) an active state to actively exchange data with a Node B or (ii) an inactive state when there is no data to send or receive. The UE may transition from the inactive state to the active state whenever there is data to send and may be assigned resources for a high-speed channel to send the data. However, the state transition may incur signaling overhead and may also delay transmission of data. It is desirable to reduce the amount of signaling in order to improve system efficiency and reduce delay.

### SUMMARY

Techniques for supporting efficient UE operation with enhanced uplink for inactive state are described herein. Enhanced uplink refers to the use of a high-speed channel having greater transmission capability than a slow common channel on the uplink. A UE may be allocated resources for the high-speed channel for enhanced uplink while in an inactive state and may more efficiently send data using the allocated resources in the inactive state.

In one design, a UE may select a signature from a set of signatures available for random access for enhanced uplink. The UE may generate an access preamble based on the selected signature and may send the access preamble for random access while operating in an inactive state, e.g., a CELL_FACH state or an Idle mode. The UE may receive allocated resources for the UE from a shared control channel, which may be a shared control channel for a high-speed downlink shared channel (HS-SCCH). The allocated resources may be for an enhanced dedicated channel (E-DCH), which is a high-speed channel for the uplink. The UE may send data to a Node B using the allocated resources and may remain in the inactive state while sending the data to the Node B.

In one design, the UE may determine a pre-assigned UE identity (ID) associated with the selected signature. The UE may obtain received symbols for the shared control channel and may de-mask the received symbols based on the pre-assigned UE ID to obtain demasked symbols for a response sent on the shared control channel to the UE.

The UE may then decode the demasked symbols to obtain decoded symbols for a codeword. The UE may determine a resource configuration based on the codeword and may determine the allocated resources for the ULE based on the resource configuration. The UE may determine that a negative acknowledgement (NACK) is sent for the access preamble if the codeword has a designated value.

In one design, the signatures available for random access for the enhanced uplink may be associated with different pre-assigned UE IDs. In one design, multiple resource configurations may be associated with different codewords. The mapping between signatures and pre-assigned UE IDs and the mapping between resource configurations and codewords may be conveyed to the UE (e.g., via broadcast) or known a priori by the UE.

Various aspects and features of the disclosure are described in further detail below.

### BRIEF DESCRIPTION OF THE DRAWINGS

FIG. 1 shows a wireless communication system.

FIG. 2 shows a state diagram of Radio Resource Control (RRC) states.

FIG. 3 shows a design of E-DCH resource allocation based on the HS-SCCH.

FIG. 4 shows a processing unit for sending allocated E-DCH resources.

FIG. 5 shows a process performed by a UE for random access.

FIG. 6 shows a process for receiving allocated resources by the UE.

FIG. 7 shows a process for supporting random access by a Node B.

FIG. 8 shows a process for sending allocated resources by the Node B.

FIG. 9 shows a block diagram of the UE and the Node B.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.20, IEEE 802.16 (WiMAX), 802.11 (WiFi), Flash-OFDM®, etc. UTRA and E-UTRA are part of Universal Mobile Telecommunication System (UMTS). 3GPP Long Term Evolution (LTE) is an upcoming release of UMTS that uses E-UTRA. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for WCDMA, and 3GPP terminology is used in much of the description below.

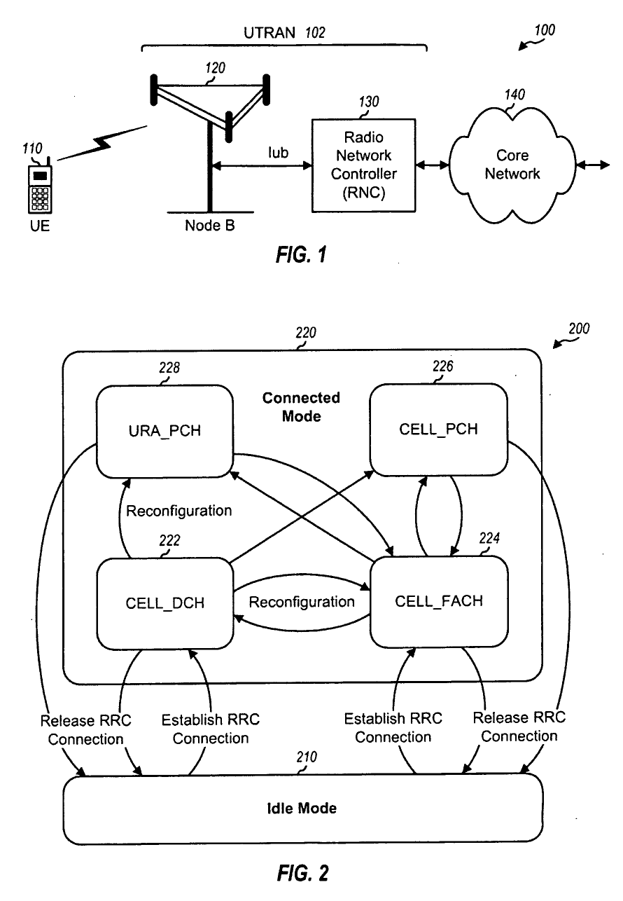

FIG. 1 shows a wireless communication system 100, which includes a Universal Terrestrial Radio Access Network (UTRAN) 102 and a core network 140. UTRAN 102 may include a number of Node Bs and other network entities. For simplicity, only one Node B 120 and one Radio Network Controller (RNC) 130 are shown in FIG. 1 for UTRAN 102. A Node B may be a fixed station that communicates with the UEs and may also be referred to as an evolved Node B (eNB), a base station, an access point, etc. Node B 120 provides communication coverage for a particular geographic area. The coverage area of Node B 120 may be partitioned into multiple (e.g., three) smaller areas. Each smaller area may be served by a respective Node B subsystem. In 3GPP, the term “cell” can refer to the smallest coverage area of a Node B and/or a Node B subsystem serving this coverage area.

RNC 130 may couple to Node B 120 and other Node Bs via an Tub interface and may provide coordination and control for these Node Bs. RNC 130 may also communicate with network entities within core network 140. Core network 140 may include various network entities that support various functions and services for UEs.

A UE 110 may communicate with Node B 120 via the downlink and uplink. UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

3GPP Release 5 and later supports High-Speed Downlink Packet Access (HSDPA). 3GPP Release 6 and later supports High-Speed Uplink Packet Access (HSUPA). HSDPA and HSUPA are sets of channels and procedures that enable high-speed packet data transmission on the downlink and uplink, respectively.

In WCDMA, data for a UE may be processed as one or more transport channels at a higher layer. The transport channels may carry data for one or more services such as voice, video, packet data, etc. The transport channels may be mapped to physical channels at a physical layer. The physical channels may be channelized with different channelization codes and may thus be orthogonal to one another in the code domain. WCDMA uses orthogonal variable spreading factor (OVSF) codes as the channelization codes for the physical channels.

Table 1 lists some transport channels in WCDMA.

TABLE 1
Transport Channels

| Channel | Channel Name | Description |
|---|---|---|
| DCH | Dedicated | Carry data on downlink or uplink for a |
| | Channel | specific UE. |
| HS-DSCH | High Speed | Carry data sent on downlink to different |
| | Downlink Shared | UEs for HSDPA. |
| | Channel | |
| E-DCH | Enhanced | Carry data sent on uplink by a UE for |
| | Dedicated | HSUPA. |
| | Channel | |
| RACH | Random Access | Carry access preambles and messages sent |
| | Channel | by UEs on uplink for random access. |
| FACH | Forward Access | Carry messages sent on downlink to UEs |
| | Channel | for random access. |
| PCH | Paging Channel | Carry paging and notification messages. |

Table 2 lists some physical channels in WCDMA.

TABLE 2
Physical Channels

| | Channel | Channel Name | Description |
|---|---|---|---|
| | PRACH | Physical Random Access | Carry the RACH. |
| | | Channel | |
| | AICH | Acquisition Indicator | Carry acquisition indicators sent |
| | | Channel | on downlink to UEs. |
| | F-DPCH | Fractional Dedicated | Carry Layer 1 control information, |
| | | Physical Channel | e.g., power control commands. |
| HSDPA | HS-SCCH | Shared Control Channel | Carry control information for data |
| | (Downlink) | for HS-DSCH | sent on the HS-PDSCH. |
| | HS-PDSCH | High Speed Physical | Carry data sent on the HS-DSCH |
| | (Downlink) | Downlink Shared Channel | to different UEs. |
| | HS-DPCCH | Dedicated Physical Control | Carry ACK/NACK for data sent |
| | (Uplink) | Channel for HS-DSCH | on the HS-PDSCH and channel |
| | | | quality indicator (CQI). |
| HSUPA | E-DPCCH | E-DCH Dedicated Physical | Carry control information for the |
| | (Uplink) | Control Channel | E-DPDCH. |
| | E-DPDCH | E-DCH Dedicated Physical | Carry data sent on the E-DCH by |
| | (Uplink) | Data Channel | a UE. |
| | E-HICH | E-DCH Hybrid ARQ | Carry ACK/NACK for data sent |
| | (Downlink) | Indicator Channel | on the E-DPDCH. |
| | E-AGCH | E-DCH Absolute | Carry absolute grants of E-DCH |
| | (Downlink) | Grant Channel | resources. |
| | E-RGCH | E-DCH Relative | Carry relative grants of E-DCH |
| | (Downlink) | Grant Channel | resources. |

WCDMA supports other transport channels and physical channels that are not shown in Tables 1 and 2 for simplicity. The transport channels and physical channels in WCDMA are described in 3GPP TS 25.211, entitled “Physical channels and mapping of transport channels onto physical channels (FDD),” which is publicly available.

FIG. 2 shows a state diagram 200 of Radio Resource Control (RRC) states for a UE in WCDMA. Upon being powered on, the UE may perform cell selection to find a suitable cell from which the UE can receive service. The UE may then transition to an Idle mode 210 or a Connected mode 220 depending on whether there is any activity for the UE. In the Idle mode, the UE has registered with the system, listens for paging messages, and updates its location with the system as necessary. In the Connected mode, the UE can receive and/or transmit data depending on its RRC state and configuration.

In the Connected mode, the UE may be in one of four possible RRC states—a CELL_DCH state 222, a CELL_FACH state 224, a CELL_PCH state 226, and a URA_PCH state 228, where URA stands for User Registration Area. The CELL_DCH state is characterized by (i) dedicated physical channels being allocated to the UE for the downlink and uplink and (ii) a combination of dedicated and shared transport channels being available to the UE. The CELL_FACH state is characterized by (i) no dedicated physical channels being allocated to the UE, (ii) a default common or shared transport channel being assigned to the UE for use to access the system, and (iii) the UE continually monitoring the FACH for signaling such as Reconfiguration messages. The CELL_PCH and URA_PCH states are characterized by (i) no dedicated physical channels being allocated to the UE, (ii) the UE periodically monitoring the PCH for pages, and (iii) the UE not being permitted to transmit on the uplink.

While in the Connected mode, the system can command the UE to be in one of the four RRC states based on activity of the UE. The UE may transition (i) from any state in the Connected mode to the Idle mode by performing a Release RRC Connection procedure, (ii) from the Idle mode to the CELL_DCH or CELL_FACH state by performing an Establish RRC Connection procedure, and (iii) between the RRC states in the Connected mode by performing a Reconfiguration procedure.

The modes and states for the UE in WCDMA are described in 3GPP TS 25.331, entitled “Radio Resource Control (RRC); Protocol Specification,” which is publicly available. The various procedures for transitioning to/from the RRC states as well as between the RRC states are also described in 3GPP TS 25.331.

UE 110 may operate in the CELL_FACH state when there is no data to exchange, e.g., send or receive. UE 110 may transition from the CELL_FACH state to the CELL_DCH state whenever there is data to exchange and may transition back to the CELL_FACH state after exchanging the data. UE 110 may perform a random access procedure and an RRC Reconfiguration procedure in order to transition from the CELL_FACH state to the CELL_DCH state. UE 110 may exchange various signaling messages for these procedures. The message exchanges may increase signaling overhead and may further delay transmission of data by UE 110. In many instances, UE 110 may have only a small message or a small amount of data to send, and the signaling overhead may be especially high in these instances. Furthermore, UE 110 may send a small message or a small amount of data periodically, and performing these procedures each time UE 110 needs to send data may be very inefficient.

In an aspect, an enhanced uplink (EUL) is provided to improve UE operation in an inactive state. In general, an inactive state may be any state or mode in which a UE is not allocated dedicated resources for communication with a Node B. For RRC, an inactive state may comprise the CELL_FACH state, the CELL_PCH state, the URA_PCH state, or the Idle mode. An inactive state may be in contrast to an active state, such as the CELL_DCH state, in which a UE is allocated dedicated resources for communication with a Node B.

The enhanced uplink for inactive state may also be referred to as an Enhanced Random Access Channel (E-RACH), enhanced uplink in CELL_FACH state and Idle mode, an enhanced uplink procedure, etc. The enhanced uplink may (i) reduce latency of user plane and control plane in the inactive state, (ii) support higher peak rates for UEs in the inactive state, and (iii) reduce state transition delay between different RRC states.

For the enhanced uplink, UE 110 may be allocated E-DCH resources for data transmission on the uplink in response to an access preamble sent by the UE. In general, any resources may be allocated to UE 110 for the enhanced uplink. In one design, the allocated E-DCH resources may include the following:
E-DCH code—one or more OVSF codes for use to send data on the E-DPDCH,
E-AGCH code—an OVSF code to receive absolute grants on the E-AGCH,
E-RGCH code—an OVSF code to receive relative grants on the E-RGCH, and
F-DPCH position—location in which to receive power control commands to adjust transmit power of UE 110 on the uplink.

Other resources may also be allocated to UE 110 for the enhanced uplink.

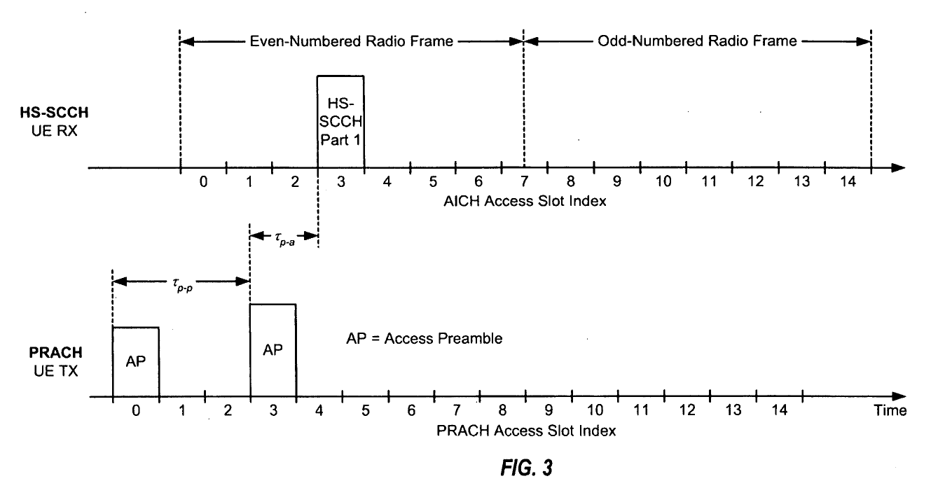

FIG. 3 shows a design of E-DCH resource allocation based on the HS-SCCH for the enhanced uplink. In WCDMA, the transmission timeline for each link is partitioned into units of radio frames, with each radio frame covering 10 milli-seconds (ms). For the PRACH, each pair of radio frames is partitioned into 15 PRACH access slots with indices of 0 through 14. For the AICH, each pair of radio frames is partitioned into 15 AICH access slots with indices of 0 through 14. Each PRACH access slot is associated with a corresponding AICH access slot that is rp a 7680 chips (or 2 ms) away. For other physical channels such as the HS-SCCH, each radio frame may be partitioned into 15 slots with indices of 0 through 14.

UE 110 may operate in the CELL_FACH state and may desire to send data. UE 110 may randomly select a signature from a set of signatures available for random access. UE 110 may generate an access preamble based on the selected signature and may send the access preamble on the PRACH in a PRACH access slot available for random access transmission. UE 110 may then listen for a response on the HS-SCCH in the corresponding AICH access slot. If a response is not received on the HS-SCCH, then UE 110 may resend the access preamble on the PRACH at higher transmit power after a period of at least τₚ₋ₚ=15,360 chips (or 4 ms). In the example shown in FIG. 3, UE 110 receives a response on the HS-SCCH in AICH access slot 3. The response may convey allocated E-DCH resources for the UE, as described below.

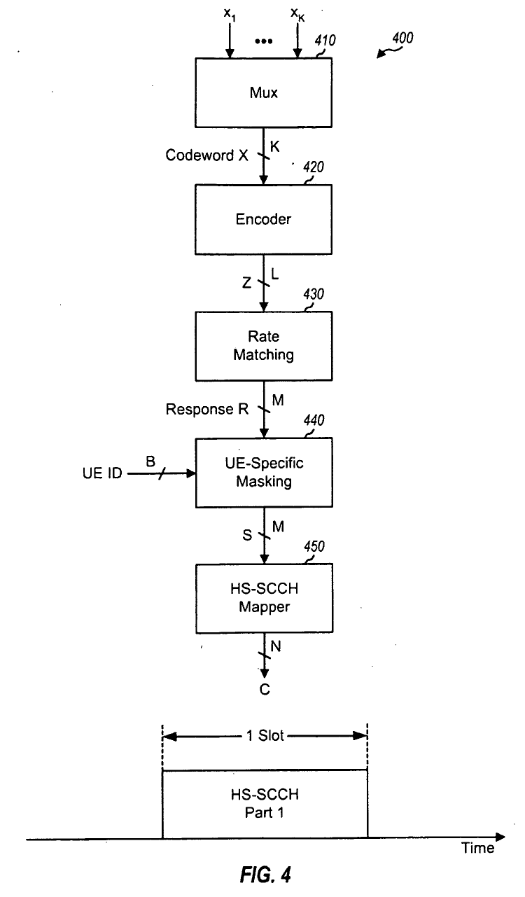

FIG. 4 shows a block diagram of a design of a processing unit 400 that can send allocated E-DCH resources to UE 110 for the enhanced uplink. Within processing unit 400, a multiplexer (Mux) 410 receives K information bits denoted as x₁ through XK and provides a codeword X comprising these K information bits, where K may be any suitable value. The K information bits may convey the allocated E-DCH resources for UE 110, as described below. An encoder 420 encodes the codeword and provides L code bits denoted as Z, where L may be any suitable value. A rate-matching unit 430 receives the L code bits from encoder 420, deletes some of the code bits, and provides M rate-matched bits for a response R to an access preamble sent by UE 110, where M may be any suitable value. A UE-specific masking unit 440 receives a UE ID of B bits, generates M scrambling bits based on the UE ID, masks the M rate-matched bits with the M scrambling bits, and provides M output bits denoted as S. An HS-SCCH mapper 450 spreads the M output bits with an OVSF code for the HS-SCCH and provides N output chips, where N may be any suitable value.

In one design, encoder 420 encodes K=8 information bits for a codeword based on a rate ⅓ convolutional code and provides L=48 code bits. In this design, there are 256 valid codewords for 8 information bits. The codewords may also be referred to as words, messages, etc. Rate-matching unit 430 receives the 48 code bits, deletes 8 code bits, and provides M=40 rate-matched bits. Masking unit 440 receives a UE ID of B=16 bits, encodes the 16 bits of the UE ID with a rate 1/2 convolutional code to obtain 48 scrambling bits, deletes 8 scrambling bits, and provides 40 scrambling bits. Masking unit 440 then performs a bit-wise exclusive OR (XOR) of the 40 rate-matched bits with the 40 scrambling bits and provides 40 output bits.

In one design, HS-SCCH mapper 450 maps the 40 output bits to 20 output symbols, spreads these 20 output symbols with a 128-chip OVSF code for the HS-SCCH, and provides N=2560 output chips for HS-SCCH part 1. To achieve lower miss detection and error detection probabilities, the 2560 output chips for the HS-SCCH part I may be transmitted twice in two successive slots of one AICH access slot, e.g., as shown in FIG. 3. In another design, HS-SCCH mapper 450 spreads the 20 output symbols with a 256-chip OVSF code for the HS-SCCH and provides N=5120 output chips for the HS-SCCH part 1, which may be sent in two slots of one AICH access slot. For both designs, the HS-SCCH part 1 may be sent based on the timing of the AICH, as shown in FIG. 3.

The HS-SCCH is typically used to send control information for data transmissions sent on the HS-PDSCH to different UEs with HSDPA. The control information for each data transmission typically includes HS-SCCH part 1 sent in the first slot as well as HS-SCCH part 2 sent in two subsequent slots. The HS-SCCH may be used to send allocated E-DCH resources to UEs performing random access for the enhanced uplink, as described above. These UEs may monitor the HS-SCCH (instead of the AICH) for responses to access preambles sent by these UEs.

The system may support both “legacy” UEs that do not support the enhanced uplink as well as “new” UEs that support the enhanced uplink. A mechanism may be used to distinguish between the legacy UEs performing the conventional random access procedure and the new UEs using the enhanced uplink. In one design, T available signatures for random access on the PRACH may be divided into two sets—a first set of P signatures available for legacy UEs and a second set of Q signatures available for new UEs, where P, Q and T may each be any suitable value such that P+Q=T. One or both sets of signatures may be broadcast to the UEs or may be known a priori by the UEs. The T available signatures may be assigned indices of 0 through T−1.

In one design, T=16 signatures available for the PRACH may be divided into two sets, with each set including 8 signatures. The legacy UEs may use the 8 signatures in the first set for the conventional random access procedure, and the new UEs may use the 8 signatures in the second set for the enhanced uplink. A Node B can distinguish between signatures from the legacy UEs and signatures from the new UEs. The Node B may perform the conventional random access procedure for each legacy UE and may operate with the enhanced uplink for each new UE. The first and second sets may also include some other number of signatures.

In one design, the Q signatures available for random access for the enhanced uplink may be associated with (i.e., mapped one-to-one to) Q pre-assigned UE IDs. Each signature may be mapped to a different pre-assigned UE ID. The pre-assigned UE IDs may be HS-DSCH Radio Network Temporary Identifiers (H-RNTIs) or some other types of UE ID. The mapping of signatures to pre-assigned UE IDs may be broadcast to the UEs or may be known a priori by the UEs.

Table 3 shows a design of mapping Q=8 signatures available for random access for the enhanced uplink to 8 16-bit H-RNTIs.

TABLE 3
Mapping of signatures to H-RNTIs

| Signature | |
|---|---|
| Index | H-RNTI |
| 1 | 0000000000000000 |
| 2 | 0101111111000000 |
| 3 | 1111010100001000 |
| 4 | 1010101011001000 |
| 5 | 0011100100010111 |
| 6 | 0110011011010111 |
| 7 | 1100001010001111 |
| 8 | 1001110101001111 |

In general, any number of signatures (Q) may be mapped to a corresponding number of H-RNTIs based on any suitable mapping. The number of signatures may be selected based on various factors such as the number and/or percentage of new UEs supporting the enhanced uplink, the amount of E-DCH resources available for the enhanced uplink, etc.

UE 110 may select a signature from among the Q signatures available for the enhanced uplink, generate an access preamble based on the selected signal, and send the access preamble on the PRACH. A Node B may send an E-DCH resource allocation to UE 110 by using the pre-assigned UE ID associated with the signature selected by UE 110. In particular, the Node B may generate scrambling bits based on the pre-assigned UE ID and may mask a response for the access preamble with the scrambling bits.

In one design, Y E-DCH resource configurations may be defined, where Y may be any suitable value. For example, Y may be equal to 8, 16, 32, etc. Each E-DCH resource configuration may be associated with specific E-DCH resources, e.g., specific resources for the E-DCH, E-AGCH, E-RGCH, F-DPCH, etc. The Y E-DCH resource configurations may be for different E-DCH resources, which may have the same or different transmission capacities. The Y E-DCH resource configurations may be conveyed via a broadcast message or made known to the new UEs in other manners.

In one design, the Y E-DCH resource configurations may be conveyed with Y codewords for the K information bits sent in HS-SCCH part 1. One codeword (e.g., codeword 0) may be used to convey a NACK to indicate that no E-DCH resource configuration is allocated.

Table 4 shows a design of mapping Y=31 E-DCH resource configurations to 31 codewords. The 31 E-DCH resource configurations are denoted as E-DCH RI through E-DCH R31. In the design shown in Table 4, the first codeword is reserved for a NACK response to an access preamble, and the next 31 codewords are used to indicate different E-DCH resource configurations. A new UE's response upon detecting a NACK may be identical to a legacy UE's response to a NACK in the conventional random access procedure. If a new UE detects a discontinuous transmission (DTX) for the HS-SCCH part 1, then the new UE's response may be identical to a legacy UE's response to a DTX in the conventional random access procedure. For example, the new UE may resend the access preamble if a DTX is received for the HS-SCCH.

TABLE 4
Mapping of E-DCH resource configurations to codewords

| E-DCH | | | | | | | | |
|---|---|---|---|---|---|---|---|---|
| Resource | Information Bits | | | | | | | |
| Configuration | x₁ | x₂ | x₃ | x₄ | x₅ | x₆ | x₇ | x₈ |
| NACK | 0 | 0 | 0 | 0 | 0 | 0 | 0 | 0 |
| E-DCH R1 | 0 | 0 | 1 | 0 | 1 | 0 | 0 | 0 |
| E-DCH R2 | 1 | 1 | 0 | 1 | 0 | 0 | 1 | 0 |
| E-DCH R3 | 1 | 1 | 1 | 1 | 1 | 0 | 1 | 0 |
| E-DCH R4 | 0 | 1 | 0 | 1 | 0 | 1 | 0 | 1 |
| E-DCH R5 | 0 | 1 | 1 | 1 | 1 | 1 | 0 | 1 |
| E-DCH R6 | 1 | 0 | 0 | 0 | 0 | 1 | 1 | 1 |
| E-DCH R7 | 1 | 0 | 1 | 0 | 1 | 1 | 1 | 1 |
| E-DCH R8 | 1 | 0 | 0 | 1 | 0 | 1 | 0 | 0 |
| E-DCH R9 | 1 | 0 | 1 | 1 | 1 | 1 | 0 | 0 |
| E-DCH R10 | 0 | 1 | 0 | 0 | 0 | 1 | 1 | 0 |
| E-DCH R11 | 0 | 1 | 1 | 0 | 1 | 1 | 1 | 0 |
| E-DCH R12 | 1 | 1 | 0 | 0 | 0 | 0 | 0 | 1 |
| E-DCH R13 | 1 | 1 | 1 | 0 | 1 | 0 | 0 | 1 |
| E-DCH R14 | 0 | 0 | 0 | 1 | 0 | 0 | 1 | 1 |
| E-DCH R15 | 0 | 0 | 1 | 1 | 1 | 0 | 1 | 1 |
| E-DCH R16 | 1 | 1 | 0 | 1 | 0 | 0 | 0 | 0 |
| E-DCH R17 | 1 | 1 | 1 | 1 | 1 | 0 | 0 | 0 |
| E-DCH R18 | 0 | 1 | 0 | 0 | 0 | 1 | 0 | 0 |
| E-DCH R19 | 0 | 1 | 1 | 0 | 1 | 1 | 0 | 0 |
| E-DCH R20 | 0 | 0 | 0 | 0 | 0 | 0 | 1 | 0 |
| E-DCH R21 | 0 | 0 | 1 | 0 | 1 | 0 | 1 | 0 |
| E-DCH R22 | 1 | 0 | 0 | 1 | 0 | 1 | 1 | 0 |
| E-DCH R23 | 1 | 0 | 1 | 1 | 1 | 1 | 1 | 0 |
| E-DCH R24 | 0 | 0 | 0 | 1 | 0 | 0 | 0 | 1 |
| E-DCH R25 | 0 | 0 | 1 | 1 | 1 | 0 | 0 | 1 |
| E-DCH R26 | 1 | 0 | 0 | 0 | 0 | 1 | 0 | 1 |
| E-DCH R27 | 1 | 0 | 1 | 0 | 1 | 1 | 0 | 1 |
| E-DCH R28 | 1 | 1 | 0 | 0 | 0 | 0 | 1 | 1 |
| E-DCH R29 | 1 | 1 | 1 | 0 | 1 | 0 | 1 | 1 |
| E-DCH R30 | 0 | 1 | 0 | 1 | 0 | 1 | 1 | 1 |
| E-DCH R31 | 0 | 1 | 1 | 1 | 1 | 1 | 1 | 1 |

In the design shown in Table 4, 32 out of 256 possible codewords are used, and the remaining 224 codewords are not used. The 32 codewords may be selected to be as far apart from each other as possible in order to improve decoding performance. The 256 codewords are obtained with 8 information bits normally sent for the HS-SCCH part 1. In another design, the 32 codewords may be represented with 5 information bits, which may be encoded with a suitable code to obtain 40 code bits. The E-DCH resource configurations may also be mapped to codewords in other manners.

In general, any number of E-DCH resource configurations (Y) may be mapped to a corresponding number of codewords based on any suitable mapping. The number of E-DCH resource configurations may be selected based on various factors such as the amount of E-DCH resources available for the enhanced uplink, the number of UEs expected to operate with the enhanced uplink at any given moment, etc. In one design, one codeword may be used to indicate that a UE should use the RACH for PRACH message transmission. In this case, the UE may observe the defined timing relationship between a PRACH preamble and a PRACH message transmission.

A Node B may receive one or more access preambles from one or more new UEs in a given PRACH access slot and may be able to respond to one UE on the HS-SCCH. The Node B may be able to send responses to multiple UEs in the same AICH access slot by using multiple HS-SCCHs, with a different OVSF code being used for each HS-SCCH. The OVSF codes for all HS-SCCHs may be broadcast to the UEs or made known to the UEs in other manners.

The techniques described herein may provide certain advantages. First, the number of E-DCH resource configurations that may be allocated to each signature may be scalable (or easily increased) without any change to the design. Second, the E-DCH resource allocation may be conveyed using the existing HS-SCCH, which may allow for reuse of existing Node B and UE equipment. Third, ACK/NACK for an access preamble and E-DCH resource allocation may be sent in a link efficient manner on the HS-SCCH. Fourth, the E-DCH resources may be quickly allocated and conveyed via the HS-SCCH. Fifth, the signatures for the enhanced uplink may be decoupled from the E-DCH resource configurations, which may support a scalable design. Other advantages may also be obtained with the techniques described herein.

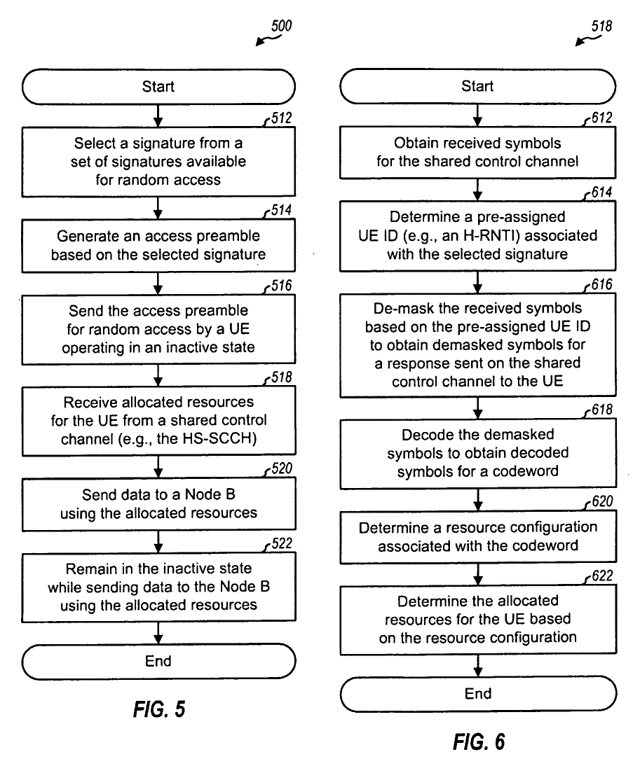

FIG. 5 shows a design of a process 500 performed by a UE for random access. The UE may select a signature from a set of signatures available for random access for enhanced uplink (block 512). This set may include a subset of all signatures available for random access. The UE may generate an access preamble based on the selected signature (block 514). The UE may send the access preamble for random access while operating in an inactive state, e.g., a CELL_FACH state or an Idle mode (block 516).

The UE may receive allocated resources for the UE from a shared control channel (block 518). In one design, the allocated resources may be for the E-DCH and the shared control channel may be the HS-SCCH in WCDMA. The UE may send data to a Node B using the allocated resources (block 520). The UE may remain in the inactive state while sending data to the Node B using the allocated resources (block 522).

FIG. 6 shows a design of receiving allocated resources by the UE in block 518 in FIG. 5. The UE may process (e.g., despread) the shared control channel based on one or more channelization codes used to send allocated resources to UEs performing random access for the enhanced uplink. The UE may obtain received symbols for the shared control channel (block 612). The UE may also determine a pre-assigned UE ID (e.g., an H-RNTI) associated with the selected signature (block 614).

The UE may de-mask the received symbols based on the pre-assigned UE ID to obtain demasked symbols for a response sent on the shared control channel to the UE (block 616). The UE may decode the demasked symbols to obtain decoded symbols for a codeword (block 618). The decoding may include de-rate matching, convolutional decoding, etc. The UE may determine a resource configuration based on the codeword (block 620). The UE may then determine the allocated resources for the UE based on the resource configuration (block 622). The UE may determine that a NACK is sent for the access preamble if the codeword has a designated value, e.g., 0.

In one design, the signatures in the set of signatures available for random access for the enhanced uplink may be associated with different pre-assigned UE IDs based on a one-to-one mapping between signatures and pre-assigned UE IDs. In one design, a plurality of resource configurations may be associated with different codewords based on a one-to-one mapping between resource configurations and codewords. The mappings may be conveyed to the ULE (e.g., via broadcast) or known a priori by the UE.

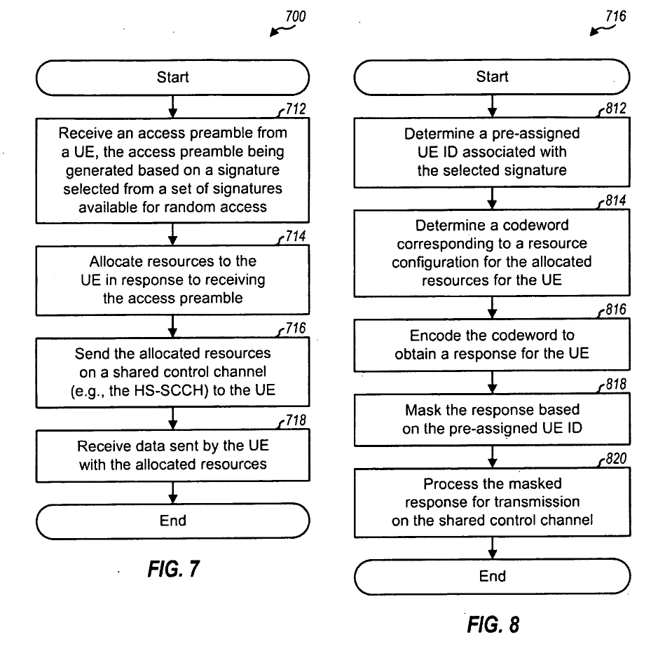

FIG. 7 shows a design of a process 700 for supporting random access by a Node B. The Node B may receive an access preamble from a UE, with the access preamble being generated based on a signature selected from a set of signatures available for random access for the enhanced uplink (block 712). The Node B may allocate resources to the UE in response to receiving the access preamble (block 714). The Node B may send the allocated resources on a shared control channel (e.g., the HS-SCCH) to the UE (block 716). The Node B may thereafter receive data sent by the UE with the allocated resources (block 718).

FIG. 8 shows a design of sending allocated resources by the Node B in block 716 in FIG. 7. The Node B may determine a pre-assigned UE ID associated with the selected signature (block 812). The Node B may determine a codeword corresponding to a resource configuration for the allocated resources for the UE (block 814). The Node B may select a codeword of a designated value to indicate a NACK being sent for the access preamble. The Node B may encode the codeword to obtain a response for the UE (block 816). The encoding may include convolutional encoding, rate matching, etc. The Node B may then mask the response based on the pre-assigned UE ID (block 818). The Node B may further process (e.g., spread) the masked response for transmission on the shared control channel (block 820).

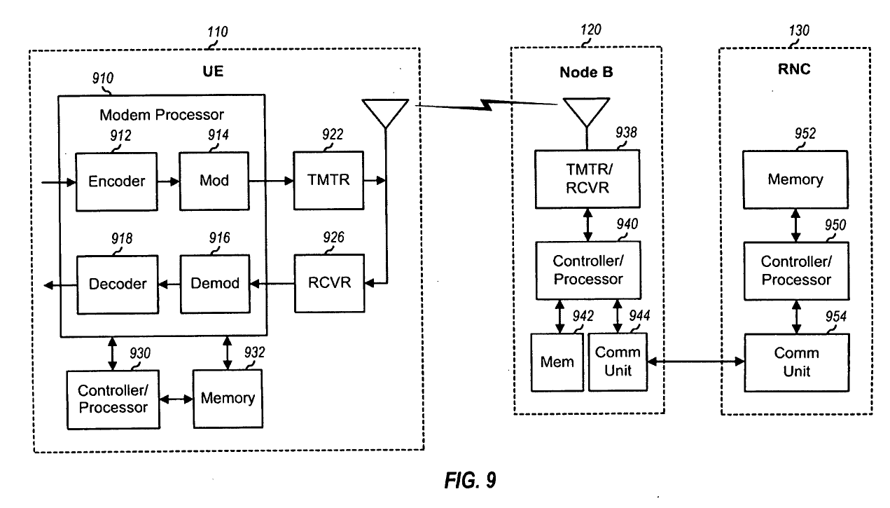

FIG. 9 shows a block diagram of a design of UE 110, Node B 120, and RNC 130 in FIG. 1. At UE 110, an encoder 912 may receive information (e.g., access preambles, messages, data, etc.) to be sent by UE 110. Encoder 912 may process (e.g., encode and interleave) the information to obtain coded data. A modulator (Mod) 914 may further process (e.g., modulate, channelize, and scramble) the coded data and provide output samples. A transmitter (TMTR) 922 may condition (e.g., convert to analog, filter, amplify, and frequency upconvert) the output samples and generate an uplink signal, which may be transmitted to one or more Node Bs. UE 110 may also receive downlink signals transmitted by one or more Node Bs. A receiver (RCVR) 926 may condition (e.g., filter, amplify, frequency downconvert, and digitize) a received signal and provide input samples. A demodulator (Demod) 916 may process (e.g., descramble, channelize, and demodulate) the input samples and provide symbol estimates. A decoder 918 may process (e.g., deinterleave and decode) the symbol estimates and provide information (e.g., responses, messages, data, etc.) sent to UE 110. Encoder 912, modulator 914, demodulator 916, and decoder 918 may be implemented by a modem processor 910. These units may perform processing in accordance with the radio technology (e.g., WCDMA) used by the system. A controller/processor 930 may direct the operation of various units at UE 110. Controller/processor 930 may perform or direct process 500 in FIG. 5, process 518 in FIG. 6, and/or other processes for the techniques described herein. Memory 932 may store program codes and data for UE 110.

At Node B 120, a transmitter/receiver 938 may support radio communication with UE 110 and other UEs. A controller/processor 940 may perform various functions for communication with the UEs. For the uplink, the uplink signal from UE 110 may be received and conditioned by receiver 938 and further processed by controller/processor 940 to recover the information (e.g., access preambles, messages, data, etc.) sent by UE 110. For the downlink, information (e.g., responses, messages, data, etc.) may be processed by controller/processor 940 and conditioned by transmitter 938 to generate a downlink signal, which may be transmitted to UE 110 and other UEs. Controller/processor 940 may perform or direct process 700 in FIG. 7, process 716 in FIG. 8, and/or other processes for the techniques described herein. Memory 942 may store program codes and data for Node B 120. A communication (Comm) unit 944 may support communication with RNC 130 and other network entities.

At RNC 130, a controller/processor 950 may perform various functions to support communication services for the UEs. Memory 952 may store program codes and data for RNC 130. A communication unit 954 may support communication with Node B 120 and other network entities.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
selecting a signature from a set of signatures available for random access;
generating an access preamble based on the selected signature;
sending the access preamble for random access by a user equipment (UE) operating in an inactive state;
receiving allocated resources for the UE from a shared control channel; and
sending data to a Node B using the allocated resources.

2. The method of claim 1, wherein the receiving allocated resources comprises
determining a pre-assigned UE identity (ID) associated with the selected signature,
performing de-masking for the shared control channel based on the pre-assigned UE ID to obtain a response sent on the shared control channel to the UE, and
determining the allocated resources for the UE based on the response.

3. The method of claim 2, wherein the signatures in the set of signatures available for random access are associated with different pre-assigned UE IDs based on a one-to-one mapping between signatures and pre-assigned UE IDs.

4. The method of claim 1, wherein the receiving allocated resources comprises
receiving a codeword from the shared control channel,
determining a resource configuration associated with the codeword, and
determining the allocated resources for the UE based on the resource configuration.

5. The method of claim 4, wherein the receiving allocated resources further comprises determining a negative acknowledgement (NACK) being sent for the access preamble if the codeword has a designated value.

6. The method of claim 4, wherein a plurality of resource configurations are associated with different codewords based on a one-to-one mapping between resource configurations and codewords.

7. The method of claim 1, wherein the receiving allocated resources comprises
obtaining received symbols for the shared control channel,
determining a pre-assigned UE identity (ID) associated with the selected signature,
de-masking the received symbols based on the pre-assigned UE ID to obtain demasked symbols,
decoding the demasked symbols to obtain decoded symbols,
determining a resource configuration based on the decoded symbols, and
determining the allocated resources for the UE based on the resource configuration.

8. The method of claim 1, wherein the receiving allocated resources comprises processing the shared control channel based on a channelization code used to send allocated resources to UEs performing random access.

9. The method of claim 1, further comprising:
remaining in the inactive state while sending data to the Node B using the allocated resources.

10. The method of claim 1, wherein the inactive state comprises a CELL_FACH state or an Idle mode.

11. The method of claim 1, wherein the allocated resources comprise resources for an enhanced dedicated channel (E-DCH), and wherein the shared control channel comprises a shared control channel for a high-speed downlink shared channel (HS-SCCH).

12. An apparatus for wireless communication, comprising:
at least one processor configured to select a signature from a set of signatures available for random access, to generate an access preamble based on the selected signature, to send the access preamble for random access by a user equipment (UE) operating in an inactive state, to receive allocated resources for the UE from a shared control channel, and to send data to a Node B using the allocated resources.

13. The apparatus of claim 12, wherein the at least one processor is configured to determine a pre-assigned UE identity (ID) associated with the selected signature, to perform de-masking for the shared control channel based on the pre-assigned UE ID to obtain a response sent on the shared control channel to the UE, and to determine the allocated resources for the UE based on the response.

14. The apparatus of claim 12, wherein the at least one processor is configured to receive a codeword from the shared control channel, to determine a resource configuration associated with the codeword, and to determine the allocated resources for the UE based on the resource configuration.

15. The apparatus of claim 12, wherein the at least one processor is configured to obtain received symbols for the shared control channel, to determine a pre-assigned UE identity (ID) associated with the selected signature, to de-mask the received symbols based on the pre-assigned UE ID to obtain demasked symbols, to decode the demasked symbols to obtain decoded symbols, to determine a resource configuration based on the decoded symbols, and to determine the allocated resources for the UE based on the resource configuration.

16. An apparatus for wireless communication, comprising:
means for selecting a signature from a set of signatures available for random access;
means for generating an access preamble based on the selected signature;
means for sending the access preamble for random access by a user equipment (UE) operating in an inactive state;
means for receiving allocated resources for the UE from a shared control channel; and
means for sending data to a Node B using the allocated resources.

17. The apparatus of claim 16, wherein the means for receiving allocated resources comprises
means for determining a pre-assigned UE identity (ID) associated with the selected signature,
means for performing de-masking for the shared control channel based on the pre-assigned UE ID to obtain a response sent on the shared control channel to the UE, and
means for determining the allocated resources for the UE based on the response.

18. The apparatus of claim 16, wherein the means for receiving allocated resources comprises
means for receiving a codeword from the shared control channel,
means for determining a resource configuration associated with the codeword, and
means for determining the allocated resources for the UE based on the resource configuration.

19. The apparatus of claim 16, wherein the means for receiving allocated resources comprises
means for obtaining received symbols for the shared control channel,
means for determining a pre-assigned UE identity (ID) associated with the selected signature,
means for de-masking the received symbols based on the pre-assigned UE ID to obtain demasked symbols,
means for decoding the demasked symbols to obtain decoded symbols,
means for determining a resource configuration based on the decoded symbols, and
means for determining the allocated resources for the UE based on the resource configuration.

20. A computer program product, comprising:
a computer-readable medium comprising:
code for causing at least one computer to select a signature from a set of signatures available for random access,
code for causing the at least one computer to generate an access preamble based on the selected signature,
code for causing the at least one computer to send the access preamble for random access by a user equipment (UE) operating in an inactive state,
code for causing the at least one computer to receive allocated resources for the UE from a shared control channel, and
code for causing the at least one computer to send data to a Node B using the allocated resources.

21. A method for wireless communication, comprising:
receiving an access preamble from a user equipment (UE), the access preamble being generated based on a signature selected from a set of signatures available for random access;
allocating resources to the UE in response to receiving the access preamble;
sending the allocated resources on a shared control channel to the UE; and
receiving data sent by the UE with the allocated resources.

22. The method of claim 21, wherein the sending the allocated resources comprises
determining a pre-assigned UE identity (ID) associated with the selected signature,
generating a response comprising the allocated resources for the UE, and
masking the response based on the pre-assigned UE ID.

23. The method of claim 22, wherein the signatures in the set of signatures available for random access are associated with different pre-assigned UE IDs based on a one-to-one mapping between signatures and pre-assigned UE IDs.

24. The method of claim 21, wherein the sending the allocated resources comprises
determining a codeword corresponding to a resource configuration for the allocated resources, and
encoding the codeword to obtain a response for the UE.

25. The method of claim 24, wherein the sending the allocated resources further comprises selecting a codeword of a designated value to indicate a negative acknowledgement (NACK) being sent for the access preamble.

26. The method of claim 24, wherein a plurality of resource configurations are associated with different codewords based on a one-to-one mapping between resource configurations and codewords.

27. The method of claim 21, wherein the sending the allocated resources comprises
determining a pre-assigned UE identity (ID) associated with the selected signature,
determining a codeword corresponding to a resource configuration for the allocated resources,
encoding the codeword to obtain a response for the UE, and
masking the response based on the pre-assigned UE ID.

28. An apparatus for wireless communication, comprising:
at least one processor configured to receive an access preamble from a user equipment (UE), the access preamble being generated based on a signature selected from a set of signatures available for random access, to allocate resources to the UE in response to receiving the access preamble, to send the allocated resources on a shared control channel to the UE, and to receive data sent by the UE with the allocated resources.

29. The apparatus of claim 28, wherein the at least one processor is configured to determine a pre-assigned UE identity (ID) associated with the selected signature, to generate a response comprising the allocated resources for the UE, and to mask the response based on the pre-assigned UE ID.

30. The apparatus of claim 28, wherein the at least one processor is configured to determine a codeword corresponding to a resource configuration for the allocated resources, and to encode the codeword to obtain a response for the UE.

31. The apparatus of claim 28, wherein the at least one processor is configured to determine a pre-assigned UE identity (ID) associated with the selected signature, to determine a codeword corresponding to a resource configuration for the allocated resources, to encode the codeword to obtain a response for the UE, and to mask the response based on the pre-assigned UE ID.
